(19) United States
(12) Patent Application Publication
(10) Pub. No.: US 2023/0130730 A1
(43) Pub. Date: Apr. 27, 2023

(54) FILMS WITH RETORT-SHOCK RECOVERY

(71) Applicant: AMCOR FLEXIBLES NORTH AMERICA, INC., Neenah, WI (US)

(72) Inventors: James R. LAMB, Neenah, WI (US); Ankush A. Gokhale, Neenah, WI (US)

(21) Appl. No.: 17/915,732

(22) PCT Filed: Apr. 28, 2020
(86) PCT No.: PCT/US2020/030255

§ 371 Date: Sep. 29, 2022

(51) Int. Cl. B32B 27/08; B32B 27/30; B32B 27/34; B32B 27/32; B65D 65/40; B65D 75/00

(52) U.S. Cl. CPC B32B 27/08; B32B 27/306; B32B 27/34; B32B 27/32; B65D 65/40; B65D 75/008; B32B 2439/70; B32B 2307/7246; B32B 2250/05; B32B 2250/24; B32B 2307/738; B32B 2307/732; B32B 2439/46

(57) ABSTRACT

A multilayer barrier film for food packaging comprises an outer layer comprising a first polymeric material having a moisture vapor transmission rate (MVTR) of greater than or equal to 10 gram·mil/100 in²/day; a first inner layer adjacent to the outer layer, the first inner layer comprising a first retortable grade ethylene vinyl alcohol (EVOH) copolymer; a second inner layer adjacent to the first inner layer, the second inner layer comprising a second polymeric material having a moisture vapor transmission rate (MVTR) of greater than or equal to 10 gram·mil/100 in²/day; a third inner layer adjacent to the second inner layer, the third inner layer comprising a second retortable grade EVOH copolymer; and a sealing layer adjacent to the third inner layer; wherein the first polymeric material is not a retortable grade EVOH copolymer. Excellent recovery of oxygen barrier over time is achieved by these films and retortable containers made therefrom.

### TECHNICAL FIELD

The present disclosure relates to high barrier, heat sealable films for retort applications. Specifically, the films disclosed can be used for thermoformed retort packaging.

### BACKGROUND

Retort operations are used for thermal processing of food and sterilization of the primary packaging components. Food packaged in a retortable container, such as a pouch, is transferred to an autoclave where it is subjected to retort conditions including temperatures generally exceeding the boiling point of water and elevated pressures for a time period. Retortable containers, therefore, are designed to withstand retort conditions.

Ethylene-vinyl alcohol (“EVOH”) copolymers are well-known for their oxygen gas barrier properties. Effectiveness of an EVOH oxygen barrier is highly dependent on relative humidity. That is, exposure to humidity results in reduced capacity of the EVOH to provide a gas barrier, which can be measured as an oxygen transmission rate (OTR). As an oxygen gas barrier, lower OTRs are desired. In coextruded films, in addition to its oxygen barrier properties, EVOH has excellent durability, good thermoforming performance and good appearance, which are desired features in retortable containers.

Some films for retort utilize a protective high moisture barrier outer layer on an EVOH-containing film. Even so, an increase in OTR after exposure of retortable containers to retort conditions is expected due to exposure of the container to wet-heat conditions. This temporary increase in OTR is referred to as retort-shock. The loss in oxygen barrier/increase in OTR is, for the most part, reversible and the oxygen barrier recovers as the material dries out. Some EVOH-containing retortable containers in the state of the art can experience long retort-shock recovery times in that only after a longer period of time (days/weeks) does the oxygen barrier become fully established again.

Although there are other barrier materials such as SiOx or LCPs (Liquid Crystal Polymer) which show no retort-shock, these materials either cannot be deep-drawn (e.g. for meal trays/containers) or are unfavorably priced.

Some other retort packaging products may combine materials such as oriented polyethylene terephthalate (OPET), biaxially-oriented nylon (BON), AlOx, foil, and the like with a polypropylene sealant. Such products are made by laminating multiple plies to form, for example, 3-ply and 4-ply structures. Again, these laminations cannot be deep-drawn.

There is an on-going need to provide EVOH-containing films for packaging that provide good retort-shock recovery, a long shelf-life, a high barrier to oxygen, and optical clarity.

### SUMMARY

Excellent recovery of oxygen barrier post heat processing is achieved by films and retortable containers disclosed herein, improving the overall shelf-life expectancy of any given packaged product.

A first aspect is a multilayer barrier film for food packaging comprising: a first outer layer comprising a first polymeric material having a moisture vapor transmission rate (MVTR) of greater than or equal to 10 gram·mil/100 in²/day; a first inner layer adjacent to the first outer layer, the first inner layer comprising a first retortable grade ethylene vinyl alcohol (EVOH) copolymer; a second inner layer adjacent to the first inner layer, the second inner layer comprising a second polymeric material having a moisture vapor transmission rate (MVTR) of greater than or equal to 10 gram·mil/100 in²/day; a third inner layer adjacent to the second inner layer, the third inner layer comprising a second retortable grade ethylene vinyl alcohol (EVOH) copolymer; and second outer layer comprising a sealing layer adjacent to the third inner layer; wherein the first polymeric material is not a retortable grade ethylene vinyl alcohol (EVOH) copolymer.

Another aspect is a multilayer barrier film for food packaging comprising: a first outer layer comprising a first polyamide; a first inner layer adjacent to the first outer layer, the first inner layer comprising a first retortable grade ethylene vinyl alcohol (EVOH) copolymer; a second inner layer adjacent to and in direct contact with the first inner layer, the second inner layer comprising a second polyamide; a third inner layer adjacent to and in direct contact with the second inner layer, the third inner layer comprising a second retortable grade ethylene vinyl alcohol (EVOH) copolymer; a fourth inner layer adjacent to and in direct contact with the third inner layer, the fourth inner layer comprising a polymeric material comprising a polyamide or a polypropylene; and a second outer layer adjacent to the fourth inner layer; wherein the multilayer barrier film is thermoformable and has thickness in a range of from about 38.1 micrometers (1.5 mils) to about 1,143 micrometers (45 mils).

A further aspect includes retortable containers comprising any multilayer barrier film of the present disclosure. The retortable container may comprise a bottom web comprising a film that is thermoformed, and a top web comprising a film that is not thermoformed; wherein at least one of the bottom web and the top web comprise the multilayer barrier film. The retortable container may be in the form of a pouch comprising one or more sidewalls formed from the multilayer barrier film. The retortable container may comprise a pouch comprising a sidewall and a gusset; wherein at least one of the sidewall and the gusset comprise the multilayer barrier film.

In an aspect, a method of making a multilayer barrier film for food packaging comprises: extruding a first polymer resin of a first polymeric material through a die thereby forming a first outer layer, the first outer layer comprising a first polymeric material having a moisture vapor transmission rate (MVTR) of greater than or equal to 10 gram·mil/100 in²/day; extruding a second polymer resin of a first retortable grade ethylene vinyl alcohol (EVOH) copolymer through a die thereby forming a first inner layer; extruding a third polymer resin of a second polymeric material through a die thereby forming a second inner layer, the second inner layer comprising a second polymeric material having a moisture vapor transmission rate (MVTR) of greater than or equal to 10 gram·mil/100 in²/day; extruding a fourth polymer resin of a second retortable grade ethylene vinyl alcohol (EVOH) copolymer through a die thereby forming a third inner layer; and forming a second outer layer from one or more extrudable polymer resins.

The method may further comprise extruding a fifth polymer resin through a die thereby forming a fourth inner layer located between the third inner layer and the second outer layer. The second outer layer may comprise sublayers that are coextruded, such that a first sublayer of the second outer layer comprises a polyolefin and a second sublayer of the second outer layer is a tie layer, such that the second sublayer is between the first sublayer and either the third or the fourth inner layer.

Another aspect is a method of packaging food in a retortable container, the method comprising: obtaining any retortable container of the disclosure; packaging food in the retortable container; and exposing the retortable container to retort conditions.

### BRIEF DESCRIPTION OF THE DRAWINGS

The disclosure may be more completely understood in consideration of the following detailed description of various embodiments of the disclosure in connection with the accompanying drawings, in which:

FIG. 1 is a cross-sectional view of an exemplary multilayer barrier film;

FIG. 2 is a cross-sectional view of another exemplary multilayer barrier film;

FIG. 3 is an exploded perspective view of an exemplary retortable container;

FIG. 4 is a plan view of an exemplary retortable container;

FIG. 5 is a plan view of an exemplary retortable container;

FIG. 6 is a schematic side view of an exemplary retortable container; and

FIG. 7 is a plan view of an exemplary retortable container;

FIG. 8 is a graph of oxygen transmission rate (OTR) versus time for exemplary films;

FIG. 9 is a graph of oxygen transmission rate (OTR) versus time for comparative films;

FIG. 10 is a graph of oxygen transmission rate (OTR) versus time for exemplary films; and

FIG. 11 is a graph of oxygen transmission rate (OTR) versus time for comparative films.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

Provided are films and retortable containers that provide excellent retort-shock recovery. A quickly recovering oxygen transmission rate (OTR) after exposure to retort conditions can be achieved by films that include a moisture transmissive outer layer in conjunction with two inner ethylene-vinyl alcohol (“EVOH”)-containing layers separated by another moisture transmissive layer. A moisture transmissive layer may comprise a polymeric material having a moisture vapor transmission rate (MVTR) of greater than or equal to 10 gram·mil/100 in²/day. A highly moisture transmissive layer may comprise a polymeric material having a moisture vapor transmission rate (MVTR) of greater than or equal to 20 gram·mil/100 in²/day. When two or more EVOH-based layers in multilayered films are located adjacent the moisture transmissive outer layer, retort-shock recovery can be improved by positioning films of polymeric materials having a moisture vapor transmission rate (MVTR) of greater than or equal to 10 gram·mil/100 in²/day as an outer layer and between the EVOH-based layers.

In one or more embodiments, the moisture transmissive or highly moisture transmissive layer comprises a polyamide, which is also hygroscopic. As such, it would be expected that the polyamide layers absorb water during retort. The films herein, however, unexpectedly display excellent retort recovery over time despite the presence of material that is moisture transmissive located between the EVOH-based layers. The films herein, however, unexpectedly display excellent retort recovery over time despite the presence of material that is hygroscopic located between the EVOH-based layers. As compared to films having a polyamide outer layer but a polyolefin, such as polypropylene between the EVOH-based layers and either a polyamide layer between an EVOH layer and a sealing layer, or no such inner polyamide layer, inventive films herein show a lower ingress of oxygen over time, for example, over a presumed shelf-life of a product.

The multilayered films herein are advantageous for thermoformed packages. For example, the films herein are suitable for a semi-rigid or flexible thermoformed web, combined with a lid, where the lid may or may not be according to the multilayered films herein. The multilayered films herein provide a durable oxygen layer while being handled and processed in different ways. Benefits of the multilayered films herein relative to other retort structures containing, for example, AlOx or SiOx, include the ability of the multilayered films to be thermoformed or otherwise stretched and abused without compromising the oxygen barrier.

The following definitions are used herein:

A “layer” as used herein refers to a building block of films that is a structure of a single polymer-type or a blend of polymers or that may have an additive. As used herein, layers are “adjacent” if they are next to each other, with or without an intervening layer such as a bonding layer. As used herein, layers are in “direct contact” if they share a common interface.

Reference to “outer layer” as used herein refers to the portion of the film that is located outermost of all the layers.

An “inner layer” as used herein refers to a layer is that is not exposed to handling and the environment. Inner layers may provide functionality as needed for particular applications. Inner layers generally allow for thermoforming of the entire film. In addition, inner layers may provide barrier protection and/or structural strength. An exemplary inner layer is a barrier layer, which provides protection to packaged food for freshness and/or a barrier to moisture and/or oxygen. Barrier layers may also protect EVOH layers from migration from package contents (for example, oils and the like). An exemplary inner layer may also be a structural layer, which provides one or more of: general durability, puncture strength, resistance to curling, and flex crack resistance.

A “sealing layer” is one that can be heat sealed to itself or another sealing layer to form a hermetic seal. That is, the sealing layer comprises a thermoplastic polymer or polymer mixture that softens when exposed to heat or other energy sources and returns to its original condition when cooled to room temperature.

As used herein, the term “polymer” refers to the product of a polymerization reaction, and is inclusive of homopolymers, copolymers, terpolymers, etc. In general, the layers of a film can consist essentially of a single polymer, or can have still additional polymers together therewith, i.e., blended therewith.

As used herein, the term “copolymer” refers to polymers formed by the polymerization of at least two different monomers. As used herein, a copolymer identified in terms of a plurality of monomers, e.g., “propylene/ethylene copolymer”, refers to a copolymer in which either monomer may copolymerize in a higher weight or molar percent than the other monomer or monomers. However, the first listed monomer preferably polymerizes in a higher weight percent than the second listed monomer.

As used herein, “EVOH” refers to ethylene vinyl alcohol copolymer. EVOH is otherwise known as saponified or hydrolyzed ethylene vinyl acetate copolymer and refers to a vinyl alcohol copolymer having an ethylene comonomer. EVOH is prepared by the hydrolysis (or saponification) of an ethylene-vinyl acetate copolymer. The degree of hydrolysis is preferably from about 50 to 100 mole percent, more preferably from about 85 to 100 mole percent, and most preferably at least 97%. It is well known that to be a highly effective oxygen barrier, the hydrolysis-saponification must be nearly complete, i.e., to the extent of at least 97%. EVOH is commercially available in resin form with various percentages of ethylene and there is a direct relationship between ethylene content and melting point. It is expected that processability and orientation would be facilitated at higher ethylene contents; however, gas permeability, particularly with respect to oxygen, may become undesirably high for certain packaging applications which are sensitive to microbial growth in the presence of oxygen. Conversely, lower ethylene content may provide lower gas permeabilities, but processability and orientation may be more difficult. Preferably, EVOH comprises from about 27-48 mole % ethylene, or even 27-38 mole % ethylene.

Reference to “retortable grade” EVOH copolymer is an EVOH copolymer in film-form that does not melt or otherwise degrade under “retort conditions”, which are exposure to high temperature steam or superheated water at ˜120° C.±5° C. for about 30 to 60 minutes at 30 pounds per square inch (psi) atmosphere.

Reference to “retort durable” polyamide refers to a polyamide in film-form that does not melt or otherwise degrade under “retort conditions”, which are exposure to high temperature steam or superheated water at −120° C.±5° C. for about 30 to 60 minutes at 30 pounds per square inch (psi) atmosphere. In one or more embodiments, a layer comprising a retortable durable polyamide exhibits no whitening after exposure to superheated water spray at ˜120° C.±5° C. for 60 minutes at 30 psi.

As used herein, the term “polyamide” refers to homopolymers or copolymers having an amide linkage between monomer units which may be formed by any method known to those skilled in the art. Useful polyamide homopolymers include nylon 6 (polycaprolactam), and the like. Other useful polyamide homopolymers also include nylon 6,6 (polyhexamethylene adipamide). Useful polyamide copolymers include nylon 6,6/6 copolymer (polyhexamethylene adipamide/caprolactam copolymer), nylon 6/6,6 copolymer (polycaprolactam/hexamethylene adipamide copolymer), as well as other nylons which are not particularly delineated here. Other useful polyamides may be block copolymers of polyamide, such as the polyether/polyamide block copolymers sold under the tradename Pebax® MV 3000 by Arkema Technical Polymers. Further suitable copolymers include nylons sold under the tradename Ultramid® C33LN 01 (PA6/66 grade) by BASF and under the tradename 5033 FD825 (PA6/66) by UBE.

Reference to “moisture vapor transmission rate” (MVTR) is the ability of a polymeric layer to transmit moisture therethrough as measured in accordance with ASTM-1249-13 entitled “Standard Test Method for Water Vapor Transmission Rate Through Plastic Film and Sheeting Using a Modulated Infrared Sensor.” Conditions for measurement include: atmospheric pressure, 38° C., and 90% relative humidity.

Reference to “oxygen transmission rate” (OTR) is the ability of a polymeric film to transmit oxygen therethrough as measured in accordance with ASTM-1927-14 entitled “Standard Test Method for Determination of Oxygen Gas Transmission Rate, Permeability and Permeance at Controlled Relative Humidity Through Barrier Materials Using a Coulometric Detector.” Conditions for measurement include: 1 atm pressure, 23° C., and 50% relative humidity on exterior side and 90% relative humidity on interior (sealant side).

The term “tie layer,” “adhesive layer,” or “adhesive coating,” refers to a material placed on one or more layers, partially or entirely, to promote the adhesion of that layer to another surface. Preferably, adhesive layers or coatings are positioned between two layers of a multilayer film to maintain the two layers in position relative to each other and prevent undesirable delamination. Unless otherwise indicated, a tie layer or an adhesive layer or coating can have any suitable composition that provides a desired level of adhesion with the one or more surfaces in contact with the adhesive layer material. Optionally, a tie layer or an adhesive layer or coating placed between a first layer and a second layer in a multilayer film may comprise components of both the first layer and the second layer to promote simultaneous adhesion of the adhesive layer to both the first layer and the second layer to opposite sides of the adhesive layer.

A “sidewall” is a discrete piece of polymer film or multi-layer laminate that is sealed to itself or another sidewall by, for example, welding or an adhesive, to form a pouch or a bag.

### Films

The multilayer films, as well as containers having such films, preferably have seal strength, stability, heat resistance, and oxygen and water vapor transmission properties that allow them to be subjected to retort conditions without loss of desired functional characteristics. The films disclosed herein may also be used for pasteurization purposes.

For example, after exposure to retort conditions, a seal strength is generally from about 5 N/15 mm (863 g/in) to about 100 N/15 mm (17,267 g/in), and typically from about 6 N/15 mm (1,036 g/in) to about 50 N/15 mm (8,634 g/in), according to ASTM-F88 with a crosshead speed of 12 in/min (30.48 cm/min). Advantageously, seal strength retention is also exhibited, based on a loss in seal strength of generally less than about 35%, typically less than about 20%, and often less than about 10%, upon being subjected to retort conditions.

Furthermore, multilayer films described herein also have acceptable heat resistance, in terms of resisting delamination or other visible defects. Preferably, no delamination of the film structure is observed after the film is subjected to 100° C. (212° F.) for 30 minutes, or even for 60 minutes.

Further properties of representative films include an equilibrium oxygen transmission rate of less than 0.4 cc/m²·day after a 145-hour recovery period after exposure to 250° F. water spray for 1 hour and 30 pounds per square inch. Film may have a retort recovery rate of greater than or equal to 90% or even 95%, over about 46.5 hours after exposure to retort conditions of 250° F. 5° F. for 60 minutes and 30 psi overpressure. It is understood that the time after exposure to retort conditions is for steady state conditions after conditioning time for the ASTM OTR testing method, which is typically 4.25 to 5 hours, including about 4.5 hours. Data collection typically starts after the testing equipment and loaded sample have completed a conditioning cycle and enough time has elapsed to measure the first data point.

Representative multilayer films are also in compliance with regulations set forth under 21 C.F.R. § 177.1390, hereby incorporated by reference.

The thickness of the multilayer film may have a minimum of about 38.1 microns (1.5 mils), about 50.8 microns (2.0 mils), about 76.2 microns (3.0 mils), about 101.6 microns (4 mils) or about 127 microns (5 mils). The thickness of the multilayer barrier film may have a maximum of about 254 microns (10 mils), about 381 microns (15 mils), about 508 microns (20 mils), about 762 microns (30 mils) or about 1,143 microns (45 mils). For example, the total thickness of a representative, multilayer film, as described herein, which may be used in the formation of retortable containers is generally in a range of from about 38.1 microns (1.5 mils) to about 1,143 microns (45 mils), or in the range of from about 101.6 microns (4 mils) to about 760 microns (29.9 mils).

### Materials

The multilayer film comprises a first outer layer, which upon formation of a container, is disposed furthest from the container contents. The first outer layer is moisture transmissive or highly moisture transmissive. In one or more embodiments, the first outer layer comprises a first polymeric material having a moisture vapor transmission rate (MVTR) of greater than or equal to 10 gram·mil/100 in²/day, including greater than 10 gram·mil/100 in²/day, greater than or equal to 20 gram·mil/100 in²/day, greater than 20 gram·mil/100 in²/day, greater than or equal to 25 gram·mil/100 in²/day, or greater than or equal to 30 gram·mil/100 in²/day. In one or more embodiments, the moisture vapor transmission rate (MVTR) of the first polymeric material of the first outer layer is less than or equal to 80 gram·mil/100 in²/day, including less than or equal to 70 gram·mil/100 in²/day, less than or equal to 60 gram·mil/100 in²/day or less than or equal to 40 gram·mil/100 in²/day. For example, in an embodiment of the multilayer film, the first outer layer may have an MVTR in the range of greater than 10 gram·mil/100 in²/day to less than or equal to 70 gram·mil/100 in²/day.

In one or more embodiments, the polymeric material of the first outer layer comprises a polyamide. In one or more embodiments, the polyamide comprises a nylon 6,6/6 copolymer (polyhexamethylene adipamide/caprolactam copolymer)-based polymer, or a nylon 6/6,6 copolymer (polycaprolactam/hexamethylene adipamide copolymer)-based polymer. In one or more embodiments, the polyamide comprises a nylon 6,6/6 copolymer (polyhexamethylene adipamide/caprolactam copolymer), or a nylon 6/6,6 copolymer (polycaprolactam/hexamethylene adipamide copolymer). In one or more embodiments, a first outer layer herein comprising a polyamide comprises a MVTR in a range of greater than 10 gram·mil/100 in²/day to less than 40 gram·mil/100 in²/day, and all values and subranges therebetween.

The thickness of the first outer layer is generally from about 1 micron (0.039 mils) to about 100 microns (3.9 mils), and typically from about 2 microns (0.079 mils) to about 30 microns (1.18 mils) or about 4 microns (0.16 mils) to about 25 microns (0.98 mils).

The multilayer film comprises two or more inner ethylene-vinyl alcohol (“EVOH”)-containing layers. The EVOH-containing layers independently comprise a retortable grade ethylene vinyl alcohol (EVOH). An exemplary EVOH is SoarnoL™ RB7405 (Soarus), which is a retortable grade EVOH having 29% ethylene. In one or more embodiments, the EVOH-containing layers independently comprise >97% to 100% EVOH. In one or more embodiments, the EVOH-containing layers each comprise 100% EVOH.

The volume percent of each of the EVOH-containing layers is independently from about 1 to about 20% by volume, and typically from about 1 to about 15% by volume, as compared to the entire multilayer barrier film. In one or more embodiments, total EVOH-containing layers in the multilayer film is generally from about 2 vol % to about 40 vol %, or from about 2 vol % to about 30 vol %. Preferably, a total amount of EVOH-containing layers is 20% or less, or 10% or less, or 5% or less, by weight.

The inner layer between the EVOH-containing layers is moisture transmissive or highly moisture transmissive. In one or more embodiments, the inner layer between the EVOH-containing layers comprises a second polymeric material having a moisture vapor transmission rate (MVTR) of greater than or equal to 10 gram·mil/100 in²/day, including greater than 10 gram·mil/100 in²/day, greater than or equal to 20 gram·mil/100 in²/day, greater than 20 gram·mil/100 in²/day, greater than or equal to 25 gram·mil/100 in²/day, or greater than or equal to 30 gram·mil/100 in²/day. In one or more embodiments, the moisture vapor transmission rate (MVTR) of the second polymeric material of inner layer between the EVOH-containing layers is less than or equal to 80 gram·mil/100 in²/day, including less than or equal to 70 gram·mil/100 in²/day, less than or equal to 60 gram·mil/100 in²/day or less than or equal to 40 gram·mil/100 in²/day. For example, in an embodiment of the multilayer film, the inner layer between the EVOH-containing layers may have an MVTR in the range of greater than 10 gram·mil/100 in²/day to less than or equal to 80 gram·mil/100 in²/day.

In one or more embodiments, the second polymeric material comprises a polyamide. In one or more embodiments, the polyamide comprises a nylon 6,6/6 copolymer (polyhexamethylene adipamide/caprolactam copolymer)-based polymer, or a nylon 6/6,6 copolymer (polycaprolactam/hexamethylene adipamide copolymer)-based polymer. In one or more embodiments, the polyamide comprises a nylon 6,6/6 copolymer (polyhexamethylene adipamide/caprolactam copolymer), or a nylon 6/6,6 copolymer (polycaprolactam/hexamethylene adipamide copolymer). In one or more embodiments, a layer herein comprising a polyamide comprises a MVTR in a range of greater than 10 gram·mil/100 in²/day to less than 40 gram·mil/100 in²/day, and all values and subranges therebetween.

The thickness of the inner layer between the EVOH-containing layers is generally from about 2 microns (0.079 mils) to about 20 microns (0.79 mils), and typically from about 4 microns (0.16 mils) to about 15 microns (0.59 mils).

Reference to the inner layer between the EVOH-containing layers means that any EVOH-containing layer present in the multilayer film are separated by a moisture transmissive or highly moisture transmissive layer, which may comprise for example a polymeric material comprising an MVTR of greater than or equal to 10 gram·mil/100 in²/day, for example a polyamide. When there are two EVOH-containing layers, then there is one such moisture transmissive layer therebetween in addition to the outer layer of the multilayered film. When there are three EVOH-containing layers, then there are two such moisture transmissive layers therebetween in addition to the outer layer of the multilayered film.

The second outer layer of the multilayer film generally refers to the innermost layer that is exposed to the internal contents of the container, such as food. A second outer layer comprising a sealing layer may be used for forming pouches in which case the sealing layer bonds to itself, normally by heat sealing. Also, the sealing layer may be used for bonding, at adjacent bonding surfaces, with a base material to form a peripheral seal, normally by heat sealing. The base material may be a rigid or flexible container bottom, for example comprising polypropylene or polyethylene. The base material may also be a second multilayer film of the same type or of a different type as the multilayer film. For example, in embodiments in which the retortable container is formed by folding a multilayer film upon itself and heat sealing the overlapping edges, the multilayer film and base material are necessarily the same, as are their adjacent sealing layers. In general, the sealing layer may comprise any suitable thermoplastic material including, but not limited too, synthetic polymers such as polyesters, polyamides, polyolefins, polystyrenes, and the like. Thermoplastic materials may also include any synthetic polymers that are cross-linked by either radiation or chemical reaction during a manufacturing or post-manufacturing process operation. Exemplary polyolefins include polyethylene (PE) and polypropylene (PP).

A preferred sealing layer comprises (e.g., in a major amount of greater than 50% by weight) or consists essentially of (1) a polypropylene or (2) a blend of polypropylene and at least one other polyolefin. Polyolefins include polyolefin plastomers, such as, for example polyethylene that may be blended in the sealing layer. The sealing layer may also comprise (e.g., in a major amount of greater than 50% by weight) or consist essentially of (i) a cast retortable grade polypropylene (ii) a coextruded polypropylene polymer or copolymer, or (iii) a blend of a coextruded polypropylene polymer or copolymer and at least one other polyolefin. In one particular embodiment, the sealing layer comprises 100% by weight of cast retortable grade polypropylene. A particular, representative cast retortable grade polypropylene has a density of about 0.9 g/cm³ (e.g., in the range from about 0.85 g/cm³ to about 0.95 g/cm³) and melt flow index of 2.1 g/10 min (e.g., in the range from about 1.9 g/10 min to about 2.3 g/10 min).

The thickness of the sealing layer is generally from about 1 microns (0.039 mils) to about 75 microns (3.0 mils), and typically from about 2 microns (0.079 mils) to about 25 microns (0.98 mils).

Between any of the layers, a tie layer or an adhesive coating or layer may be provided to provide adhesion and continuity between the layers. Adhesive resin compositions may include, but are not limited to: modified and unmodified polyolefins, preferably modified polypropylene including an anhydride group, modified and unmodified acrylate resin, preferably selected from the group consisting of ethylene/vinyl acrylate copolymer, ethylene/ethyl acrylate copolymer, ethylene/butyl acrylate copolymer, or blends thereof. EVA is an ethylene/vinyl acetate co-polymer, which may be used in particular to form a layer to facilitate bonding of polymerically dissimilar layers.

A tie layer or adhesive coating may suitably be less than 10% and preferably between 0.1% and 10% of the overall thickness of the multilayer film. Adhesive resins are often more expensive than other polymers so the tie layer thickness is usually kept to a minimum consistent with the desired effect.

A moisture barrier layer may be provided between the last (second or third) EVOH-containing layer and the sealing layer. The sealing layer may provide a moisture barrier.

In one or more embodiments, the multilayered films comprise less than or equal to 20% by weight of EVOH-containing materials, including less than or equal to 10% by weight, or less than or equal to 5% by weight. In one or more embodiments, the multilayered films comprise less than or equal to 20% by weight of polyamide-containing materials including less than or equal to 10% by weight, or less than or equal to 5% by weight. In one or more embodiments, the multilayered films comprise both the EVOH-containing materials and the polyamide-containing materials in independent amounts of less than or equal to 20% by weight, including less than or equal to 10% by weight, or less than or equal to 5% by weight.

### Fabrication

An exemplary multi-layered film may be formed by co-extruding several polymer resins.

One or more embodiments of a method of making a multilayer barrier film for food packaging comprises: extruding a first polymer resin of a first polymeric material through a die thereby forming a first outer layer, wherein the first polymeric material has a moisture vapor transmission rate (MVTR) of greater than or equal to 10 gram·mil/100 in2/day; extruding a second polymer resin of a first retortable grade ethylene vinyl alcohol (EVOH) copolymer through a die thereby forming a first inner layer; extruding a third polymer resin of a second polymeric material through a die thereby forming a second inner layer, wherein the second polymeric material has a moisture vapor transmission rate (MVTR) of greater than or equal to 10 gram·mil/100 in2/day; extruding a fourth polymer resin of a second retortable grade ethylene vinyl alcohol (EVOH) copolymer through a die thereby forming a third inner layer; and forming a second outer layer from one or more extrudable polymer resins.

The method may further comprise extruding a fifth polymer resin through a die thereby forming a fourth inner layer located between the third inner layer and the second outer layer.

In one or more embodiments, the second outer layer comprises sublayers, which are coextruded, such that a first sublayer of the second outer layer comprises a polyolefin and a second sublayer of the second outer layer is a tie layer, such that the second sublayer is between the first sublayer and either the third or the fourth inner layer.

To form a package, a sealing layer of any film disclosed herein is adhered to itself or another film to form a seam of a sidewall. Packages may further include indicia in their films.

Before describing several exemplary embodiments of the invention, it is to be understood that the invention is not limited to the details of construction or process steps set forth in the following description. The invention is capable of other embodiments and of being practiced or being carried out in various ways.

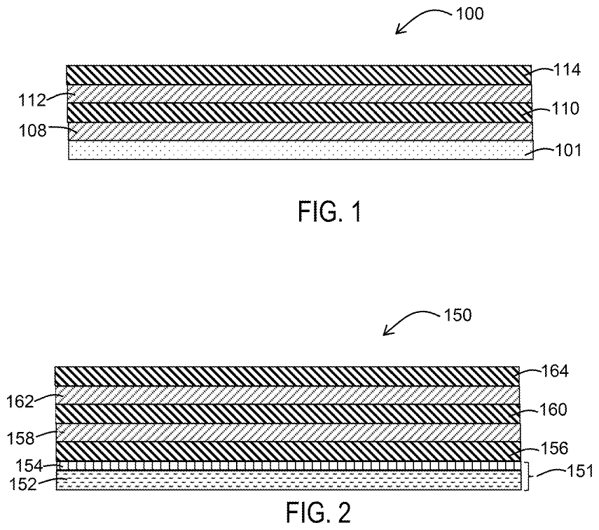

Turning to the figures, FIG. 1 is a cross-sectional view of an exemplary multilayer barrier film 100 having 5-layers. In order starting from the outside, the layers are: a first outer layer 114 comprising a first polymeric material having a moisture vapor transmission rate (MVTR) of greater than or equal to 10 gram·mil/100 in²/day, a first inner layer 112 comprising a first retortable grade ethylene vinyl alcohol (EVOH) copolymer, a second inner layer 110 of a second polymeric material having a moisture vapor transmission rate (MVTR) of greater than or equal to 10 gram·mil/100 in²/day 110, a third inner layer 108 comprising a second retortable grade ethylene vinyl alcohol (EVOH) copolymer, and a second outer layer 101, which may comprise two or more sublayers. In one or more embodiments, the second inner layer 110 and/or the second outer layer 101 further comprises an oxygen scavenging material for reacting with oxygen that permeates the package or is trapped therein.

A cross-sectional view of another exemplary multilayer barrier film 150 is provided in FIG. 2, which is a 7-layer film. In order starting from the outside, the layers are: a first outer layer 164 comprising a polyamide, a first inner layer 162 comprising a first retortable grade ethylene vinyl alcohol (EVOH) copolymer, a second inner layer 160 comprising a polyamide, a third inner layer 158 comprising a second retortable grade ethylene vinyl alcohol (EVOH) copolymer, a fourth inner layer 156 comprising a polyamide, and a second outer layer 151, which comprises two sublayers: a first sublayer 152 comprising a polyolefin and a second sublayer 154 comprising a tie layer.

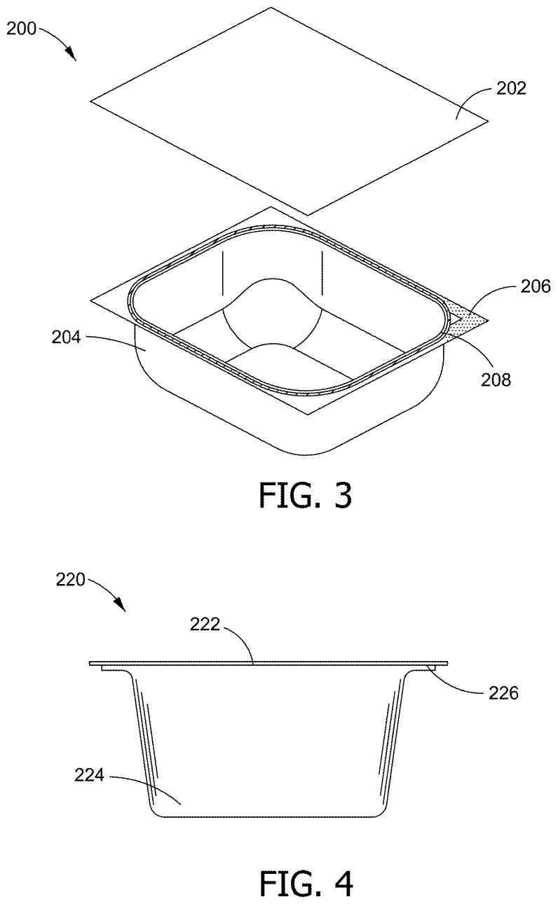

FIG. 3 is an exploded perspective view of an exemplary retortable container 200 having a top web 202 and a bottom web 204. The top web 202 is a film. In one or more embodiments, the top web 202 is according to any multilayer barrier film of the disclosure. A sealing layer (not numbered) of the top web 202 is attached to a sealing surface 206 of the bottom web 204 by a heat seal 208. In one or more embodiments, the bottom web 204 is according to any multilayer barrier film of the disclosure. In one or more embodiments, both the top web 202 and the bottom web 204 are independently in accordance with any multilayer barrier film of the disclosure. The bottom web 204 is preferably thermoformed and the top web 202 may be thermoformed, otherwise formed, or may be unformed.

FIG. 4 is a plan view of an exemplary retortable container 220 having a top web 222 and a bottom web 224. The bottom web 224 is according to any multilayer barrier film of the disclosure. The bottom web 224 is thermoformed to provide a cavity to hold a packaged product. The top web 222 is heat-sealed to a sealing surface 226 of the bottom web 224. The top web 222 is made of a film that may be the same or different as that of the bottom web 224. The top web 222 may be thermoformed, otherwise formed, or unformed.

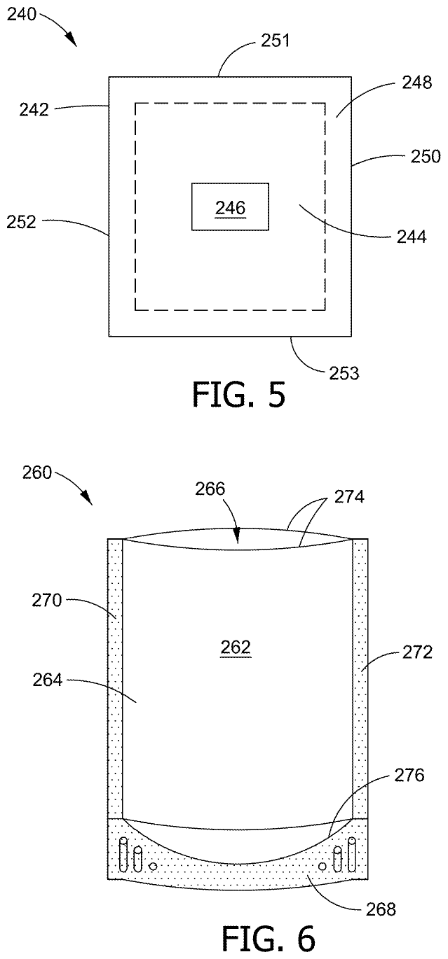

FIG. 5 is a plan view of an exemplary retortable container in the form of a hermetically sealed package 240, which includes a product 246, such as a pharmaceutical or food product, sealed within an interior 244 of the package 240 that includes any multilayer barrier film 242 of the disclosure. The product 246 is in contact with the sealing layer (not numbered) of the film 242. In some embodiments, the package 240 consists essentially of the film 242. The film 242 forms the interior 244 of the package 240 which is defined by heat seal 248 that is formed along each edge 250, 251, 252, 253 of the package. In the depicted embodiment, the dashed lines indicate the sealed portion of the package 240 that defines sealed interior 244.

FIG. 6 is a schematic side view of an exemplary retortable container in the form of a stand-up pouch 260, which may be suitable for liquid packaging. Pouch 260 comprises a sidewall 264, an opening 266 and bottom gusset 268. The sidewall 264 and/or the bottom gusset 268 may be formed from any film 262 of the disclosure. The film 262 is heat-sealed to form side seals 270, 272 and a bottom seal 276. After filling, edges 274 are heat sealed to form a top seal.

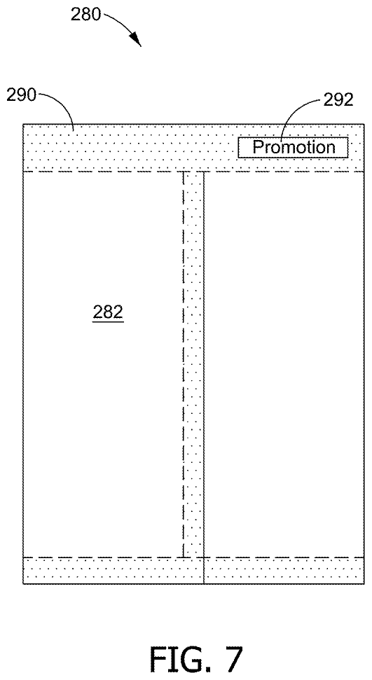

FIG. 7 is a plan view of another exemplary retortable container in the form of a pouch 280, which may be suitable for liquid packaging. Pouch 280 comprises a sidewall formed from any film 282 of the disclosure. The film 282 is heat-sealed to form seals 290. Indicia 292 may be provided as part of the film 282 at any suitable location including a location between a first and second outer layer of the film 282. Alternatively, the indicia 292 may be printed directly on the first outer layer.

As embodied by FIGS. 3-7, multilayered films herein are advantageous for any component of a retort package, specifically a thermoformed retort package. For example, the films herein are suitable for a semi-rigid or flexible thermoformed web. The films herein are also suitable for a lid to accompany the semi-rigid or flexible thermoformed web. The multilayered films herein provide a durable oxygen barrier layer while being handled and processed in different ways. A benefit of the multilayered films herein relative to other retort structures containing, for example, AlOx or SiOx, is the multilayered films herein can be deep-drawn by thermoformed. The multilayered films herein can also be otherwise stretched and abused without compromising the oxygen barrier.

### EXAMPLES

Layers made from Ultramid® C33LN (BASF), which is a copolymer PA6/66 used in the examples herein, have a moisture vapor transmission rate (MVTR) of greater than or equal to 10 gram·mil/100 in²/day. Layers made from 5033 FD825 (UBE), which is a polyamide copolymer that is nylon 6,66-based used in the examples herein, have a moisture vapor transmission rate (MVTR) of greater than or equal to 20 gram·mil/100 in²/day.

### Example 1

An asymmetric multilayer barrier film having a total thickness of 101.5 micrometers (4 mils) was manufactured by blown film coextrusion techniques having the following structure in order:

First outer layer: polyamide, nylon 6,66. Trade name: Ultramid® C33LN (BASF) which is a copolymer PA6/66.

First inner layer (first EVOH-containing layer): ethylene vinyl alcohol (EVOH) copolymer (29%). Trade name: SoarnoL™ RB7405 (Soarus)—ETHYLENE VINYL ALCOHOL COPOLYMER (EVOH), Retortable Grade.

Second inner layer: polyamide, nylon 6,66. Trade name: Ultramid® C33LN (BASF) which is a copolymer PA6/66.

Third inner layer (second EVOH-containing layer): ethylene vinyl alcohol (EVOH) copolymer (29%). Trade name: SoarnoL™ RB7405 (Soarus).

Fourth inner layer: polyamide, nylon 6,66. Trade name: Ultramid® C33LN (BASF).

Second outer layer (two sublayers): Polypropylene (PP)-based tie sublayer of Admer™ QF-500A (“QF”) (maleic anhydride-grafted polypropylene); and a PP-based sealing sublayer of a polypropylene impact copolymer PPC 4170 (Total).

The Example 1 structure is abbreviated as: PA/EVOH/PA/EVOH/PA/PP tie/PP (blown).

### Example 2

An asymmetric multilayer barrier film having a total thickness of 101.5 micrometers (4 mils) was manufactured by blown film coextrusion techniques having the following structure in order:

First outer layer: Trade name 5033 FD825 (UBE) which is a nylon 6,66-based copolymer.

First inner layer (first EVOH-containing layer): ethylene vinyl alcohol (EVOH) copolymer (29%). Trade name: SoarnoL™ RB7405 (Soarus)—ETHYLENE VINYL ALCOHOL COPOLYMER (EVOH), Retortable Grade.

Second inner layer: Trade name 5033 FD825 (UBE) which is a nylon 6,66-based copolymer.

Third inner layer (second EVOH-containing layer): ethylene vinyl alcohol (EVOH) copolymer (29%). Trade name: SoarnoL™ RB7405 (Soarus).

Fourth inner layer: Trade name: 5033 FD825 (UBE) which is a nylon 6,66-based copolymer.

Second outer layer (two sublayers): Polypropylene (PP)-based tie sublayer of Admer™ QF-500A (“QF”) (maleic anhydride-grafted polypropylene); and a PP-based sealing sublayer of a polypropylene impact copolymer PPC 4170 (Total)

The Example 2 structure is abbreviated as: PA/EVOH/PA/EVOH/PA/PP tie/PP (blown).

### Example 3

### Comparative

An asymmetric multilayer barrier film having a total thickness of 101.5 micrometers (4 mils) was manufactured by blown film coextrusion techniques having the following structure in order:

First outer layer: polyamide, nylon 6,66. Trade name: Ultramid® C33LN (BASF) which is a copolymer PA6/66.

First inner layer (first EVOH-containing layer): ethylene vinyl alcohol (EVOH) copolymer (29%). Trade name: SoarnoL™ RB7405 (Soarus)—ETHYLENE VINYL ALCOHOL COPOLYMER (EVOH), Retortable Grade.

Second inner layer: Polypropylene (PP)-based tie of Admerm QF-500A (“QF”) (maleic anhydride-grafted polypropylene).

Third inner layer (second EVOH-containing layer): ethylene vinyl alcohol (EVOH) copolymer (29%). Trade name: SoarnoL™ RB7405 (Soarus).

Fourth inner layer: polyamide, nylon 6,66. Trade name: Ultramid® C33LN (BASF) which is a copolymer PA6/66.

Second outer layer (two sublayers): Polypropylene (PP)-based tie sublayer of Admer™ QF-500A (“QF”) (maleic anhydride-grafted polypropylene); and a PP-based sealing sublayer of a polypropylene impact copolymer PPC 4170 (Total).

This structure is abbreviated as: PA/EVOH/PP tie/EVOH/PA/PP tie/PP (blown).

### Example 4

### Comparative

An asymmetric multilayer barrier film having a total thickness of 101.5 micrometers (4 mils) was manufactured by blown film coextrusion techniques having the following structure in order:

First outer layer: polyamide, nylon 6,66. Trade name: Ultramid® C33LN (BASF) which is a copolymer PA6/66.

First inner layer (first EVOH-containing layer): ethylene vinyl alcohol (EVOH) copolymer (29%). Trade name: SoarnoL™ RB7405 (Soarus)—ETHYLENE VINYL ALCOHOL COPOLYMER (EVOH), Retortable Grade.

Second inner layer: Polypropylene (PP)-based tie of Admer™ QF-500A (“QF”) (maleic anhydride-grafted polypropylene).

Third inner layer (second EVOH-containing layer): ethylene vinyl alcohol (EVOH) copolymer (29%). Trade name: SoarnoL™ RB7405 (Soarus).

Fourth inner layer: polyamide, nylon 6,66. Trade name: Ultramid® C33LN (BASF) which is a copolymer PA6/66.

Second outer layer (three sublayers): Polypropylene (PP)-based tie sublayer of Admer™ QF-500A (‘QF’) (maleic anhydride-grafted polypropylene); a first PP-based sealing sublayer of a polypropylene impact copolymer PPC 4170 (Total); and a second PP-based sealing sublayer of a polypropylene impact copolymer PPC 4170 (Total).

This structure is abbreviated as: PA/EVOH/PP tie/EVOH/PA/PP tie/PP/PP (blown).

### Example 5

### Testing

The films of Examples 1-2 and Comparative Examples 3-4 were exposed to a first set of retort conditions of 123° C. (254° F.) water spray for 1 hour at 30 psi overpressure.

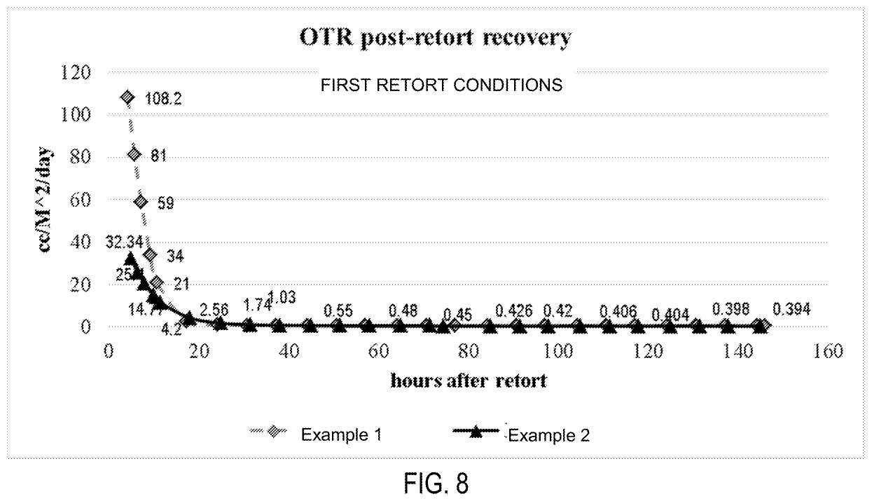

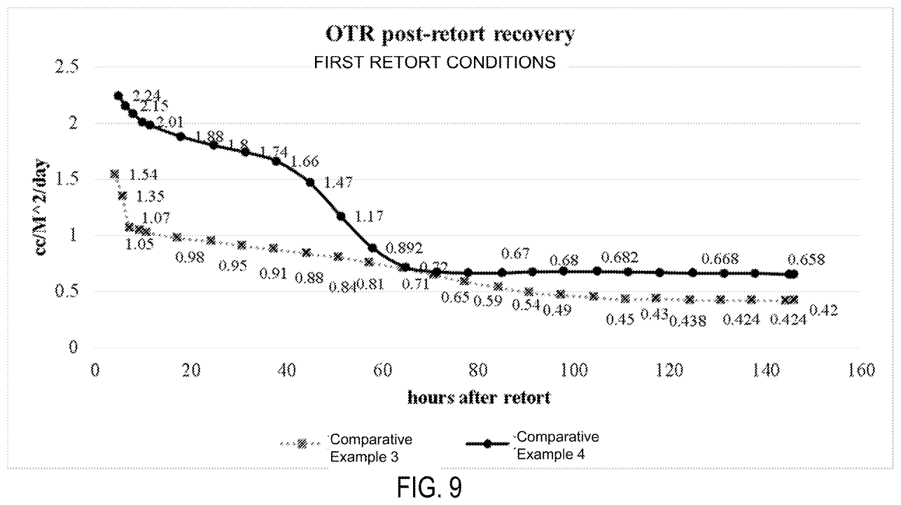

Oxygen barrier performances of these films were determined after exposure to the first retort conditions. FIG. 8 provides a graph of oxygen transmission rate (OTR) cc/m²·day versus time from the conclusion of the first retort conditions (recovery curves) that were generated for the films of Examples 1-2. FIG. 9 provides a graph of OTR cc/m²·day versus time from the conclusion of the first retort conditions (recovery curves) that were generated for the films of Comparative Examples 3-4. Table 1 provides a summary of further information regarding these films.

TABLE 1.A

| | | Visual | | |
|---|---|---|---|---|
| | | inspection of | Equilibrium | Calculated |
| | Inner | outer layer | OTR cc/m² · day | oxygen ingress |
| | Polyamide | after first | (145 hours | over 365 days |
| Example | (PA) layer | retort conditions | post-retort) | (cc/m²) |
| 1 | Nylon 6/6,6 | Blisters/white | 0.394 | 164.2 |
| | between | streaks | | |
| | EVOH | | | |
| | layers | | | |
| 2 | Retort | No blisters or | 0.322 | 126.4 |
| | durable | white streaks | | |
| | nylon 6/6,6- | | | |
| | containing | | | |
| | copolymer | | | |
| | between | | | |
| | EVOH | | | |
| | layers | | | |
| 3 COMPARATIVE | Nylon 6/6,6 | — | 0.422 | 155.4 |
| | between one | | | |
| | EVOH layer | | | |
| | and a sealing | | | |
| | layer | | | |
| 4 COMPARATIVE | None | — | 0.658 | 242.3 |

TABLE 1.B

| | Initial OTR | Final OTR | % Retort |
|---|---|---|---|
| Example | cc/m² · day | cc/m² · day | Recovery |
| 1 | 108.2 | 0.51 | 99% |
| | (at t = 4.25 hr | (at t = 50.75 hr | |
| | post retort) | post retort | |
| 2 | 32.34 | 0.47 | 96% |
| | (at t = 5 hr | (at t = 51.5 hr | |
| | post retort) | post retort) | |
| 3 COMPARATIVE | 1.54 | 0.81 | 47% |
| | (at t = 4.25 hr | (at t = 50.75 hr | |
| | post retort) | post retort) | |
| 4 COMPARATIVE | 2.24 | 1.17 | 48% |
| | (at t = 5 hr | (at t = 51.5 hr | |
| | post retort) | post retort) | |

For Example 2, the retort durable nylon 6/6,6-containing copolymer resulted in a defect-free outer layer, where no blistering or white streaks were seen upon visual inspection. Example 1, using a traditional nylon 6/6,6 copolymer, showed blisters and white streaks in the outer layer, which were seen upon visual inspection. Without intending to be bound by theory, it is thought that defects resulting from the blisters and streaks allowed more water ingress in the EVOH layers during retort. As a result, initial OTR immediately after retort was higher for Example 1 as compared to Example 2, which is shown in FIG. 8. The absence of blisters and white streaks in Example 2 resulted in lower initial OTR post-retort as compared to Example 1, which is shown in FIG. 8. Both Examples 1 and 2 recovered oxygen barrier properties (≤1 cc/m²·day) within approximately 35 hours post-retort. Retort recovery was 99% for both Examples 1 and 2, whereas retort recovery for the comparative examples was 47% for Comparative Example 3 and 48% for Comparative Example 4.

Turning to FIG. 9, initial OTR post-retort was smaller for both Comparative Examples 3 and 4 as compared to both Examples 1 and 2. OTR recovery back to ≤1 cc/m²·day for Comparative Examples 3 and 4 as compared to Examples 1 and 2, however, took longer. Looking at equilibrium OTR values (OTR after 145 hours (post-retort) of equilibration at 50% RH out/90% inside provides some explanation, without intended to be bound by theory. As seen from the equilibrium OTR data presented in Table 1, Examples 1 and 2 showed improved oxygen barrier compared to the Comparative Examples 3 and 4. Given that a shelf-life of a typical retort product is long, total oxygen ingress for the projected shelf-life can be significant. Assuming a product shelf-life of one year (365 days), an approximate amount of oxygen ingress was calculated as per the following formula:

$$Assumed Oxygen ingress = ( {\sum }_{n = 1}^{n = ∞} ( \frac{{OTR}_{n + 1} + {OTR}_{n}}{2} ) * ( \frac{{t}_{n + 1} - {t}_{n}}{24} ) ) + ( {OTR}_{∞} * ( T - \frac{{t}_{∞}}{24} ) )$$

wherein t₁ is the first time point after retort (hr), tₙ is the nth time point after retort (hr), t_{∞} is the time at which OTR reaches an equilibrium (here 145 hours), T (days) is the assumed shelf-life of product (here 365 days), OTR₁ is the OTR at timepoint t₁ (cc/(m2·day·atm)), OTRₙ is the OTR at timepoint tₙ (cc/(m2·day·atm)), and OTR_{∞} is the OTR at t_{∞} recorded in Table 1 (cc/(m2·day·atm)). OTR_{∞} is the equilibrium OTR concentration recorded in Table 1.

As shown in Table 1, Example 2 showed the lowest oxygen ingress over the assumed shelf-life of the product. This unexpected result (despite higher initial OTR post-retort) is the result of a moisture transmissive polyamide layer placement between the EVOH layers. Polyamide is a hygroscopic polymer that absorbs water during retort. Placing polyamide between two EVOH layers resulted in significantly higher initial OTR post retort. On the other hand, polypropylene between EVOH layers (Comparative Examples 3 and 4) resulted in a lower initial OTR. However, polyamide also has a relatively high MVTR (>20 gram mil/100 inch2/day), whereas polypropylene has an MVTR<5 gram mil/100 inch2/day. The relatively high MVTR of polyamide allowed the buried EVOH to dry out faster. Hence OTR recovery was faster. Both Examples 1 and 2 show sharp retort recoveries. On the other hand, Comparative Example 3 with polypropylene between two EVOH layers and Comparative Example 4 with no polyamide in the inner layers tended to confine moisture/water absorbed during retort within the buried EVOH layer for a longer period of time. As a result, retort recovery was slower. When equilibrium OTR was extrapolated to cover shelf-life of product, results showed that Example 2 showed a lower over oxygen ingress per unit area.

### Example 6

### Testing

Fresh samples of the films of Examples 1-2 and Comparative Examples 3-4 were exposed to a second set of retort conditions of 121° C. water spray for 1 hour at 40 psi atmosphere.

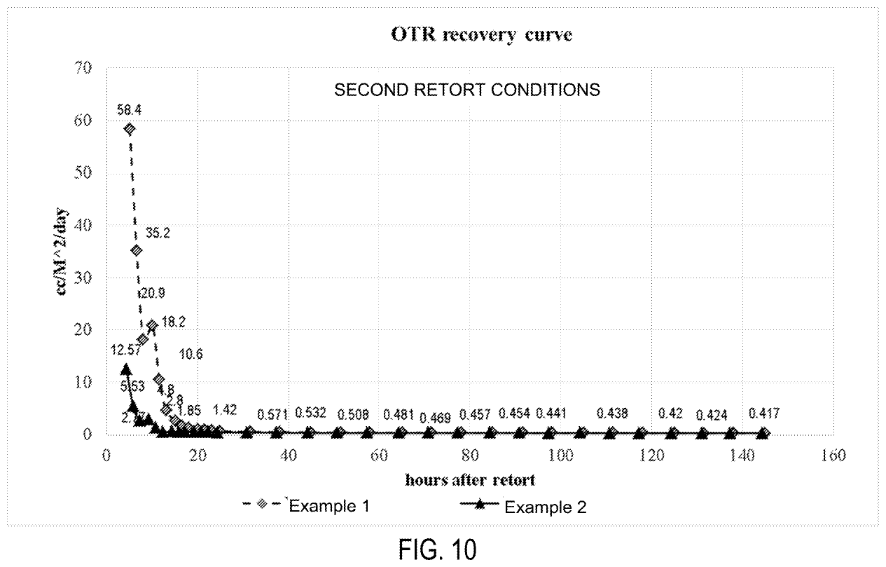

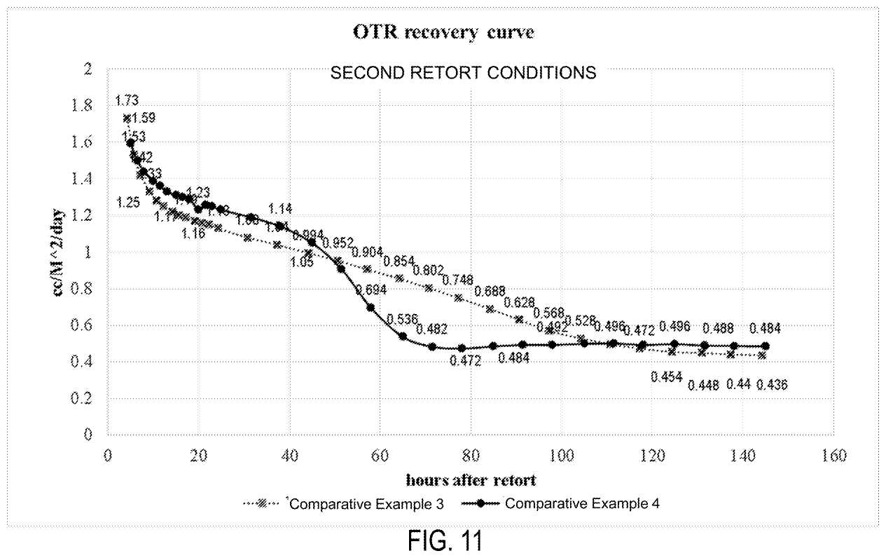

Oxygen barrier performances of these films were determined after exposure to the second retort conditions. FIG. 10 provides a graph of oxygen transmission rate (OTR) cc/m²·day versus time from the conclusion of the second retort conditions (recovery curves) that were generated for the films of Examples 1-2. FIG. 11 provides a graph of OTR cc/m²·day versus time from the conclusion of the second retort conditions (recovery curves) that were generated for the films of Comparative Examples 3-4. Tables 2.A and 2.B provide a summary of further information regarding these films.

TABLE 2.A

| | | Visual | | |
|---|---|---|---|---|
| | | inspection of | Equilibrium | Calculated |
| | Inner | outer layer | OTR cc/m² · day | oxygen ingress |
| | Polyamide | after second | (145 hours | over 365 days |
| Example | (PA) layer | retort conditions | post-retort) | (cc/m²) |
| 1 | Nylon 6/6,6 | Intense | 0.417 | 160.6 |
| | between | whitening and | | |
| | EVOH | blistering | | |
| | layers | | | |
| 2 | Retort | Significant | 0.415 | 152.8 |
| | durable | reduction in | | |
| | nylon 6/6,6- | whitening and | | |
| | containing | blistering | | |
| | copolymer | | | |
| | between | | | |
| | EVOH | | | |
| | layers | | | |
| 3 COMPARATIVE | Nylon 6/6,6 | — | 0.436 | 161.1 |
| | between one | | | |
| | EVOH layer | | | |
| | and a sealing | | | |
| | layer | | | |
| 4 COMPARATIVE | None | — | 0.484 | 178.1 |

TABLE 2.B

| | Initial OTR | Final OTR | % Retort |
|---|---|---|---|
| Example | cc/m² · day | cc/m² · day | Recovery |
| 1 | 58.4 | 0.508 | 99% |
| | (at t = 5 hr | (at t = 51.5 hr | |
| | post retort) | post retort | |
| 2 | 12.57 | 0.46 | 96% |
| | (at t = 4.25 hr | (at t = 50.75 hr | |
| | post retort) | post retort) | |
| 3 COMPARATIVE | 1.73 | 0.952 | 45% |
| | (at t = 4.25 hr | (at t = 50.75 hr | |
| | post retort) | post retort) | |
| 4 COMPARATIVE | 1.59 | 0.906 | 43% |
| | (at t = 5 hr | (at t = 51.5 hr | |
| | post retort) | post retort) | |

### EMBODIMENTS

Film Embodiment A: A multilayer barrier film for food packaging comprising:
a first outer layer comprising a first polymeric material having a moisture vapor transmission rate (MVTR) of greater than or equal to 10 gram·mil/100 in²/day;
a first inner layer adjacent to the first outer layer, the first inner layer comprising a first retortable grade ethylene vinyl alcohol (EVOH) copolymer; a second inner layer adjacent to the first inner layer, the second inner layer comprising a second polymeric material having a moisture vapor transmission rate (MVTR) of greater than or equal to 10 gram·mil/100 in²/day;
a third inner layer adjacent to the second inner layer, the third inner layer comprising a second retortable grade ethylene vinyl alcohol (EVOH) copolymer; and
a second outer layer comprising a sealing layer;
wherein the first polymeric material is not a retortable grade ethylene vinyl alcohol (EVOH) copolymer.
   Film Embodiment B: The multilayer barrier film of any other Film Embodiment, wherein the moisture vapor transmission rate (MVTR) of the first polymeric material of the first outer layer is in a range of greater than or equal to 10 gram·mil/100 in²/day to less than 80 gram·mil/100 in²/day.
   Film Embodiment C: The multilayer barrier film of any other Film Embodiment, wherein the moisture vapor transmission rate (MVTR) of the second polymeric material of the second inner layer is greater than 20 gram·mil/100 in²/day.
   Film Embodiment D: The multilayer barrier film of any other Film Embodiment, wherein the moisture vapor transmission rate (MVTR) of the second polymeric material of the second inner layer is in a range of greater than 10 gram·mil/100 in²/day to less than 80 gram·mil/100 in²/day.
   Film Embodiment E: The multilayer barrier film of any other Film Embodiment, wherein the first polymeric material of the first outer layer and the second polymeric material of the second inner layer independently comprise a polyamide.
   Film Embodiment F: The multilayer barrier film of any other Film Embodiment, wherein the first polymeric material of the first outer layer is a retort durable polyamide.
   Film Embodiment G: The multilayer barrier film of any other Film Embodiment, wherein the first outer layer is in direct contact with the first inner layer, which is in direct contact with the second inner layer, which is in direct contact with the third inner layer.
   Film Embodiment H: The multilayer barrier film of any other Film Embodiment, further comprising a fourth inner layer located between the third inner layer and the second outer layer, the fourth inner layer comprising a third polymeric material.
   Film Embodiment I: The multilayer barrier film of Film Embodiment H, wherein the third polymeric material comprises a polyamide or a polypropylene.
   Film Embodiment J: The multilayer barrier film of any other Film Embodiment, wherein the second outer layer comprises two or more sublayers.
   Film Embodiment K: The multilayer barrier film of Film Embodiment J, wherein a first sublayer of the second outer layer comprises a polyolefin and a second sublayer of the second outer layer is a tie layer, such that the second sublayer is between the first sublayer and either the third or the fourth inner layer.
   Film Embodiment L: The multilayer barrier film of one of any other Film Embodiment that is thermoformable.
   Film Embodiment M: The multilayer barrier film of any other Film Embodiment, wherein the first outer layer, the first, second, third, and fourth inner layers, and the second outer layer are coextruded.
   Film Embodiment N: The multilayer barrier film of any other Film Embodiment having a thickness in a range of from about 38.1 micrometers (1.5 mils) to about 1,143 micrometers (45 mils).
   Film Embodiment O: The multilayer barrier film of any other Film Embodiment having retort recovery rate of greater than or equal to 90% over about 46.5 after exposure to retort conditions of 250° F.±5° F. for 60 minutes and 30 psi overpressure.
   Film Embodiment P: A multilayer barrier film for food packaging comprising:
a first outer layer comprising a first polyamide;
a first inner layer adjacent to the first outer layer, the first inner layer comprising a first retortable grade ethylene vinyl alcohol (EVOH) copolymer;
a second inner layer adjacent to and in direct contact with the first inner layer, the second inner layer comprising a second polyamide;
a third inner layer adjacent to and in direct contact with the second inner layer, the third inner layer comprising a second retortable grade ethylene vinyl alcohol (EVOH) copolymer;
a fourth inner layer adjacent to and in direct contact with the third inner layer, the fourth inner layer comprising a polymeric material comprising a polyamide or a polypropylene; and
a second outer layer adjacent to the fourth inner layer;
wherein the multilayer barrier film is thermoformable and has thickness in a range of from about 38.1 micrometers (1.5 mils) to about 1,143 micrometers (45 mils).
   Film Embodiment Q: The multilayer barrier film of Film Embodiment P, wherein the first polyamide is a retort durable polyamide.
   Film Embodiment R: The multilayer barrier film Film Embodiment P or Q, wherein the moisture vapor transmission rates (MVTR) of the first outer layer and the second inner layer are independently greater than 10 gram·mil/100 in²/day to less than 40 gram·mil/100 in²/day.
   Film Embodiment 5: The multilayer barrier film of Film Embodiment P, Q or R, wherein the second outer layer comprises sublayers, such that a first sublayer of the second outer layer comprises a polyolefin and a second sublayer of the sealing layer is a tie layer, such that the first sublayer is between the first sub layer and either the third or the fourth inner layer.
   Container Embodiment A: A retortable container comprising the multilayer barrier film of any Film Embodiment.
   Container Embodiment B: The retortable container of Container Embodiment A comprising a bottom web comprising a film that is thermoformed, and a top web comprising a film that is not thermoformed; wherein at least one of the bottom web and the top web comprise the multilayer barrier film.
   Container Embodiment C: The retortable container of Container Embodiment A in the form of a pouch comprising one or more sidewalls formed from the multilayer barrier film.
   Container Embodiment D: The retortable container of Container Embodiment A comprising a pouch comprising a sidewall and a gusset; wherein at least one of the sidewall and the gusset comprise the multilayer barrier film.
   Method Embodiment A: A method of making a multilayer barrier film for food packaging, the method comprising:
extruding a first polymer resin of a first polymeric material through a die thereby forming a first outer layer, wherein the first polymeric material has a moisture vapor transmission rate (MVTR) of greater than or equal to 10 gram·mil/100 in²/day;
extruding a second polymer resin of a first retortable grade ethylene vinyl alcohol (EVOH) copolymer through a die thereby forming a first inner layer; extruding a third polymer resin of a second polymeric material through a die thereby forming a second inner layer, wherein the second polymeric material has a moisture vapor transmission rate (MVTR) of greater than or equal to 10 gram·mil/100 in²/day;
extruding a fourth polymer resin of a second retortable grade ethylene vinyl alcohol (EVOH) copolymer through a die thereby forming a third inner layer; and
forming a second outer layer from one or more extrudable polymer resins.
   Method Embodiment B: The method of Method Embodiment A further comprising extruding a fifth polymer resin through a die thereby forming a fourth inner layer located between the third inner layer and the second outer layer.
   Method Embodiment C: The method of Method Embodiment A, wherein the second outer layer comprises sublayers that are coextruded, such that a first sublayer of the second outer layer comprises a polyolefin and a second sublayer of the second outer layer is a tie layer, such that the second sublayer is between the first sublayer and either the third or the fourth inner layer.
   Method Embodiment D: A method of packaging food in a retortable container, the method comprising:
obtaining the retortable container of any Container Embodiment;
packaging a product in the retortable container; and
exposing the retortable container to retort conditions.

1. A multilayer barrier film for food packaging comprising:
a first outer layer comprising a first polymeric material having a moisture vapor transmission rate (MVTR) of greater than or equal to 10 gram·mil/100 in²/day;
a first inner layer adjacent to the first outer layer, the first inner layer comprising a first retortable grade ethylene vinyl alcohol (EVOH) copolymer;
a second inner layer adjacent to the first inner layer, the second inner layer comprising a second polymeric material having a moisture vapor transmission rate (MVTR) of greater than or equal to 10 gram·mil/100 in²/day;
a third inner layer adjacent to the second inner layer, the third inner layer comprising a second retortable grade ethylene vinyl alcohol (EVOH) copolymer; and
a second outer layer comprising a sealing layer;
wherein the first polymeric material is not a retortable grade ethylene vinyl alcohol (EVOH) copolymer, and
wherein the first polymeric material of the first outer layer and the second polymeric material of the second inner layer independently comprise a polyamide.

2. The multilayer barrier film of claim 1, wherein the moisture vapor transmission rate (MVTR) of the first polymeric material of the first outer layer is in a range of greater than or equal to 10 gram·mil/100 in²/day to less than 80 gram·mil/100 in²/day.

3. The multilayer barrier film of claim 1, wherein the moisture vapor transmission rate (MVTR) of the second polymeric material of the second inner layer is greater than 20 gram·mil/100 in²/day.

4. The multilayer barrier film of claim 1, wherein the moisture vapor transmission rate (MVTR) of the second polymeric material of the second inner layer is in a range of greater than 10 gram·mil/100 in²/day to less than 80 gram·mil/100 in²/day.

5. (canceled)

6. The multilayer barrier film of claim 1, wherein the first outer layer is in direct contact with the first inner layer, which is in direct contact with the second inner layer, which is in direct contact with the third inner layer.

7. The multilayer barrier film of claim 1 further comprising a fourth inner layer located between the third inner layer and the second outer layer, the fourth inner layer comprising a third polymeric material.

8. The multilayer barrier film of claim 7, wherein the third polymeric material comprises a polyamide or a polypropylene.

9. The multilayer barrier film of claim 1, wherein the second outer layer comprises two or more sublayers.

10. The multilayer barrier film of claim 9, wherein a first sublayer of the second outer layer comprises a polyolefin and a second sublayer of the second outer layer is a tie layer, such that the second sublayer is between the first sublayer and either the third or the fourth inner layer.

11. The multilayer barrier film of claim 1 that is thermoformable.

12. The multilayer barrier film of claim 1, wherein the first outer layer, the first, second, third, and fourth inner layers, and the second outer layer are coextruded.

13. A multilayer barrier film for food packaging comprising:
a first outer layer comprising a first polymeric material having a moisture vapor transmission rate (MVTR) of greater than or equal to 10 gram·mil/100 in²/day;
a first inner layer adjacent to the first outer layer, the first inner layer comprising a first retortable grade ethylene vinyl alcohol (EVOH) copolymer;
a second inner layer adjacent to the first inner layer, the second inner layer comprising a second polymeric material having a moisture vapor transmission rate (MVTR) of greater than or equal to 10 gram·mil/100 in²/day;
a third inner layer adjacent to the second inner layer, the third inner layer comprising a second retortable grade ethylene vinyl alcohol (EVOH) copolymer;
a second outer layer comprising a sealing layer;
wherein the first polymeric material is not a retortable grade ethylene vinyl alcohol (EVOH) copolymer, and
wherein the multilayer barrier film has a retort recovery rate of greater than or equal to 90% over about 46.5 after exposure to retort conditions of 250° F.±5° F. for 60 minutes and 30 psi overpressure.

14. A multilayer barrier film for food packaging comprising:
a first outer layer comprising a first polyamide;
a first inner layer adjacent to the first outer layer, the first inner layer comprising a first retortable grade ethylene vinyl alcohol (EVOH) copolymer;
a second inner layer adjacent to and in direct contact with the first inner layer, the second inner layer comprising a second polyamide;
a third inner layer adjacent to and in direct contact with the second inner layer, the third inner layer comprising a second retortable grade ethylene vinyl alcohol (EVOH) copolymer;
a fourth inner layer adjacent to and in direct contact with the third inner layer, the fourth inner layer comprising a polymeric material comprising a polyamide or a polypropylene; and
a second outer layer adjacent to the fourth inner layer;
wherein the multilayer barrier film is thermoformable and has thickness in a range of from about 38.1 micrometers (1.5 mils) to about 1,143 micrometers (45 mils).

15. The multilayer barrier film of claim 14, wherein the moisture vapor transmission rates (MVTR) of the first outer layer and the second inner layer are independently greater than 10 gram·mil/100 in²/day to less than 40 gram·mil/100 in²/day.

16. The multilayer barrier film of claim 14, wherein the second outer layer comprises sublayers, such that a first sublayer of the second outer layer comprises a polyolefin and a second sublayer of the sealing layer is a tie layer, such that the first sublayer is between the first sub layer and either the third or the fourth inner layer.

17. A retortable container comprising the multilayer barrier film claim 1.

18. The retortable container of claim 17 comprising a bottom web comprising a film that is thermoformed, and a top web comprising a film that is not thermoformed; wherein at least one of the bottom web and the top web comprise the multilayer barrier film.

19. The retortable container of claim 17 in the form of a pouch comprising one or more sidewalls formed from the multilayer barrier film.

20. The retortable container of claim 17 comprising a pouch comprising a sidewall and a gusset; wherein at least one of the sidewall and the gusset comprise the multilayer barrier film.
